(19) United States
(12) Patent Application Publication
(10) Pub. No.: US 2026/0087419 A1
(43) Pub. Date: Mar. 26, 2026

(54) ELECTRONIC COMPUTING DEVICES AND METHODS FOR ESTIMATING A POPULATION UNCERTAINTY DISTRIBUTION OF TRAINING DATA BY AN ELECTRONIC COMPUTING DEVICE, A COMPUTER PROGRAM PRODUCT, AND A COMPUTER-READABLE STORAGE MEDIUM

(71) Applicant: Siemens Healthineers AG, Forchheim (DE)

(72) Inventors: Manasi DATAR, Mumbai (IN); Marvin TEICHMANN, Erlangen (DE); Florin-Cristian GHESU, Baiersdorf (DE); Anja BORSDORF, Adelsdorf (DE); Fernando VEGA, Erlangen (DE); Lisa KRATZKE, Erlangen (DE)

(73) Assignee: Siemens Healthineers AG, Forchheim (DE)

(21) Appl. No.: 19/339,711

(22) Filed: Sep. 25, 2025

(30) Foreign Application Priority Data
Sep. 26, 2024 (EP) 24202761.3

(51) Int. Cl. G06N 20/20

(52) U.S. Cl. CPC G06N 20/20

(57) ABSTRACT

One or more example embodiments relates to a method for estimating a population uncertainty distribution of training data, comprising providing an artificial intelligence as an ensemble learner model comprising at least two base learners by an electronic computing device; providing the training data for training the ensemble learner model by the electronic computing device; separating the training data into a first set of training data for training one of the at least two base learners and into a second set of training data for validating another one of the at least two base learners by the electronic computing device; training the one of the at least one base learner with the first set of training data by the electronic computing device; and estimating the population uncertainty distribution by validating the another at least one base learner with the second set of training data by the electronic computing device.

### CROSS-REFERENCE TO RELATED APPLICATION(S)

The present application claims priority under 35 U.S.C. § 119 to European Patent Application No. 24202761.3, filed Sep. 26, 2024, the entire contents of which are incorporated herein by reference.

### FIELD

One or more example embodiments relates to a method for estimating a population uncertainty distribution of training data by an electronic computing device. Furthermore, one or more example embodiments relates to a corresponding computer program product, a corresponding computer-readable storage medium, as well as to a corresponding electronic computing device.

### RELATED ART

Out-of-distribution (OOD) images pose a challenge to deep learning (DL) based segmentation models. Since out of distribution images are highly different from the training data set distribution, deep learning-base segmentation methods typically produce inconsistent outputs. In the context of for example medical image analysis, examples of out of distribution inputs could include images with included artifacts, for example implants, guides/wires, markers, or furthermore. Such images may not be visually inspected before running the automated segmentation pipeline, leading to unpredictable behavior and posing a critical safety risk in the clinical workflow.

Therefore, there is a need to identify out of distribution instances and provide information about possible loss of accuracy while using automated segmentation pipelines. Most common deep learning-based segmentation methods are not designed to include out of distribution detection, therefore, an out of distribution detection method that requires minimal changes to the network architecture and can be applied post-training is required.

Existing approaches achieve an acceptable performance for out of distribution detection by using the difference between output logits or their scaled variants and the corresponding 1-hot encoding as a measure of disparity. Such methods seek to compare out of distribution inputs to plausible in-distribution (ID) examples from the training set. Explicit inclusion of an out layer/out of distribution detector during model training has been also observed in some approaches.

### SUMMARY

These approaches require out of distribution examples as part of the training process, rendering them impractical. Statistical approaches including the use of the Mahalanobis-distance have been traditionally applied to network feature distribution for out of distribution detection, which often necessitates network architecture modification, such as flattening the final encoder layer or averaging encoder feature maps. These adaptions can lead to potential feature collapse.

One or more example embodiments provides methods, corresponding computer program products, corresponding computer-readable storage mediums, as well as corresponding electronic computing devices, by which a population uncertainty distribution of training data can be estimated in an improved manner.

This solved by a method, a corresponding computer program product, a corresponding computer-readable storage medium, as well as a corresponding electronic computing device according to the independent claims. Advantageous embodiments are presented in the dependent claims.

### BRIEF DESCRIPTION OF THE DRAWINGS

Features and feature combinations of example embodiments are obtained from the figure and their description as well as the claims. In particular, further implementations of the invention may not necessarily contain all features of one of the claims. Further implementations of the invention may comprise features or combinations of features, which are not recited in the claims.

The figures show in:

FIG. 1 shows a schematic block diagram according to an embodiment of an electronic computing device;

FIG. 2 illustrates a schematic block diagram according to an embodiment of a method;

FIG. 3 illustrates another schematic block diagram according to an embodiment of a method; and

FIG. 4 illustrates another schematic block diagram according to an embodiment of a method.

### DETAILED DESCRIPTION

One or more example embodiments relates to a method for estimating a population uncertainty distribution of training data by an electronic computing device. An artificial intelligence as an ensemble learner model comprising at least two base learners is provided by the electronic computing device. The training data is provided for training the ensemble learner model by the electronic computing device. The training data is separated into a first set of training data for training one of the at least two base learners and into a second set of training data for validating another one of the at least two base learners by the electronic computing device. The at least one base learner is trained with the first set of training data by the electronic computing device and the population uncertainty distribution is estimated by validating the other at least one base learner with the second set of training data by the electronic computing device.

Ensemble learning methods are empirically known to improve accuracy and reduce generalization error for image segmentation tasks. Recently, sampling-based Bayesian ensemble method such as Monte Carlo dropout or deep ensembles have shown improved performance on image segmentation tasks. These methods provide multiple outputs for each evaluated sample, allowing for an estimation of model uncertainty. One or more example embodiments proposes a statistical method to estimate the similarity of a test sample to a distribution of uncertainty over the complete training set and further determination of out of distribution samples based on a threshold.

In particular, model ensembles are generally created by varying the choice of training data for base learners within the ensemble. For example, bootstrap aggregation or bagging is an approach where the training data set is sampled with replacement to create a subset to train base learners. One or more example embodiments proposes the use of residual bootstraps subset as the validation set for the base learner. Conversely, each training sample can be a part of the validation set for some base learners and the corresponding uncertainty map can be computed. For example, a variation of bootstrap aggregation is used, where each training sample is only exposed to half of the base learners during the training, minimizing the overlap between subset to increase diversity of the ensemble. The uncertainty map computation can be easily adapted to such variation, where each training sample can be a part of the validation set for the base learners. Further, this computation lends itself equally to deterministic learning models trained using bootstrap aggregation since it works directly with the network outputs and is applied post training.

Therefore, the method provides a way of using the complete training data set to compute a conservative estimation of the population uncertainty distribution. This computation is based on the predicted uncertainty of training data only and does not require the explicit presence of out of distribution samples for threshold selection. The method allows for a direct estimation of similarity of a test sample to the training distribution in the uncertainty space, independent of the network architecture or feature dimensionality. It can therefore be easily integrated into existing pipelines and used with pre-trained models trained using the bootstrap aggregate ensemble strategy. Contrary to previous approaches, the method proposed applies for example the Mahalanobis distance to uncertainty scores derived from class-conditional distributions, offering a method that circumvents the need for architectural changes and reduces the risk of feature collapse. The method can be extended for using applications beyond out of distribution detection with a metric chosen to be appropriate for the task at hand.

Along with uncertainty, accuracy can also be evaluated over the entire training data set using the proposed method. Statistical curves such as the receive operating characteristic, precision-recall, or accuracy versus-uncertainty curves can then be used to select an operating point or threshold to characterize the performance on the test samples. The proposed method offers the advantage that the performance curves approximate population performance better, as compared to a smaller, separate validation set that is typically used.

An ensemble learner model, which also may be regarded as the so called ensemble model, is a machine learning technique that trains multiple base models and combines their predictions to produce more accurate results than could be achieved with a single model alone. The basic idea behind ensemble methods is to leverage the strength of multiple algorithms or models, rather than relying on a single one. There are different ensemble models, for example the so-called bagging or bootstrap aggregation. This method trains multiple base models in parallel, with each model trained on a random subset of data. The final prediction is made by averaging the predictions from all the individual models. An examples of bagging algorithms include random forest. Furthermore, boosting is also a method that trains base models sequentially, with each subsequent model focusing on the errors or misclassifications made by the previous models. The final prediction is made by combining the predictions from all the individual models. Example of boosting algorithms include gradient boosting machines. Furthermore, the stacking method trains multiple base models in parallel, then uses a separate meta-model to combine their predictions. The meta-model can be any type of model that takes the individual predictions as inputs and produces a final prediction. Examples of stacking algorithms including stack generalization and blending. Ensembles most are often used in machine learning competitions and real-word applications, because they trend to produce more accurate results than single models, especially when dealing with complex or noisy data.

According to an embodiment, the training data is separated by using a bootstrap aggregation algorithm. The bootstrap aggregation is a machine learning ensemble technique that involves training models and base models in parallel and different random subset of the data, then averaging their prediction to produce a final output. This approach helps reduce overfitting and improve model performance by leveraging the diversity of the models. The basic idea behind bootstrap aggregation is to create multiple bootstrap samples from the original training data by randomly sampling with replacement. Each bootstrap sample is then used to train a base model, resulting in an ensemble of models that are diverse and can capture different patterns in the data. The final prediction is made by averaging the predictions from all the individual models. Bootstrap aggregation has several advantages over single-model approaches. For example, an improved accuracy is provided by combining multiple models, wherein bootstrap aggregation can reduce the variance of predictions and improve the overall accuracy. Furthermore, the use of random subsets of the data can help prevent overfitting and improve generalization of performance. The diversity of the ensemble can help reduce the impact of noisy or out lower observations in the training data. Bootstrap aggregation can be applied to a wide range of machine learning algorithms, including decision trees, neural networks and support vector machines. The bootstrap aggregation is also known as the so-called bagging and is commonly used in machine learning application such as random forest and back trees.

In another embodiment, the training is performed for the half of the provided base learners. For example, the base learners may be provided with the abbreviation “k”. The bootstrap aggregation or bagging is the approach where the training data set N is sampled with a replacement k times to create a subset of NK to train base learners. According to the embodiment, the use of residual bootstrap subset (N-NK) as the validation set for the kth base learner. Conversely, each training sample (xi) can be a part of the validation set for a maximum of (k−1) base learners and the corresponding uncertainty map can be computed. A variation of bootstrap aggregation is used for each training sample and may be for example exposed to half the base learners during training, minimizing the overlap between subset to increase diversity of the ensemble. The uncertainty map computation can easily be adapted to such a variation, where each training sample can be a part of the validation set for a maximum of (k/2) base learners.

According to another embodiment for validating the at least one base learner the training data is perturbed in a pre-processing step. For example, in the case of a single model trained using a static training data set, this computation can be applied by a perturbation of training samples during evaluation. Each training sample (xi), can be perturbed k times to create unseen variants of the original training sample to constitute the corresponding validation subset. Such a validation subset can be evaluated using the trained model to obtain the uncertainty map. It is therefore possible to compute a conservative estimate of the underlying population uncertainty distribution by iteratively computing the uncertainty map for every training sample.

In another embodiment, depending on the estimated population uncertainty distribution an uncertainty score for the training data is determined. For example, a voxel level uncertainty map can be post-processed to obtain the uncertainty score ui, as already mentioned. Note that the uncertainty score can be aggregated to the organ level with dimensionality M in the case of multi-organ segmentation with M distinct organs.

According to another embodiment, a plurality of training data is provided and the artificial intelligence is trained and validated with the plurality of training data. Therefore, the plurality of training data samples can be provided. Therefore, the artificial intelligence can be trained and validated in an improved manner by using the plurality of training data.

In another embodiment, an uncertainty score for the artificial intelligence is determined depending on an aggregation of a plurality of uncertainty scores of each training data. For example, to approximate the uncertainty score of the distribution for the ID-population a M class-conditional Gaussian distribution [symbol] (μₘ, Σ), m∈[1, M] over the uncertainty score of the training data computed for every single training sample is provided. For example:

$${μ}_{m} = \frac{1}{{N}_{m}} {\sum }_{i} {u}_{i , m}$$

represents the class-wise means, and

$$\sum = \frac{1}{N} {\sum }_{m = 1}^{M} {\sum }_{i} ( {u}_{i , m} - {μ}_{m} ) {( {u}_{i , m} - {μ}_{m} )}^{T} ,$$

is the covariance matrix capturing shared uncertainties across classes.

In another embodiment, a Gaussian distribution is used for determining the uncertainty score for the artificial intelligence. The Gaussian distribution, also known as the normal distribution or bell curve, is a continuous probability distribution that describes data that clusters around a mean value with characteristics well shaped. It is one of the most widely used distributions in statistics and machine learning, and it has many applications in fields for example physics, biology and engineering. The Gaussian distribution is characterized by two parameters: The mean and standard deviation. The mean represents the center of the distribution, while a standard deviation measures the spread of dispersion of the data around the mean. The Gaussian distribution is often used as a model for real-world data, particularly when the data are continuous and have an uni model distribution. It can be used to estimate probabilities, make prediction and test hypothesis about the data.

According to another embodiment, test data are provided for the trained artificial intelligence and an affiliation of the test data to the distribution of the training data is determined depending on a difference threshold between the test data and the training data. Therefore, the test data can be evaluated, if they are inside of the distribution or outside of the distribution. For example, when the test data are outside of the distribution, they can be identified as the so-called out of distribution samples. Therefore, without using or without the knowledge of such out of distribution samples, the out of distribution samples can be identified in an improved manner.

In another embodiment, a Mahalanobis distance is used for determining the difference between the test data and the training data. In particular, for each sample with a class-wise uncertainty score vector set zi the Mahalanobis distance to the above distribution is given:

$$𝒟ℳ ( {z}_{i} , 𝒩 ( {μ}_{m} , \sum ) ) = \sqrt{{\sum }_{m = 1}^{M} {( {z}_{i , m} - {μ}_{m} )}^{T} {\sum }^{- 1} ( {z}_{i , m} - {μ}_{m} )}$$

and can be used as a metric. Then, for example, one of the following methods of threshold selection may be utilized based on the specific use case. The Mahalanobis distance follows a Chi square-distribution with degrees of freedom equal to the number of features (M: number of foreground classes in this formulation), allowing for the computation of the critical value for the out of distribution detection at an application-specific significance level without necessitating out of distribution test samples. A Mahalanobis distance value covering a critical, application-specific percentage of the cumulative Mahalanobis distance curve can be used as a threshold to distinguish out of distribution test samples. Furthermore, an operating point may be selected using the class-wise performance curves based on a trade-off between accuracy and uncertainty. The Mahalanobis distance corresponding to the selected uncertainty score can be used as a threshold. Therefore, only the training data is required for the threshold estimation, no out of distribution or control samples are utilized. Also, performance based analysis can be extended further for calibration of the network based on uncertainty.

According to another embodiment, if the difference exceeds the threshold a warning message is generated. For example, the process of out of distribution detection is a test using test data. The Mahalanobis distance between the test samples and the distribution is computed and compared to the application specific threshold selected using one of the methods above. The test sample is detected as out of distribution, if the Mahalanobis distance is greater than the threshold. Therefore, the out of distribution detection can be provided in an improved manner.

In another embodiment, the artificial intelligence is used for a magnetic resonance only planning and/or a radiation therapy planning and/or a radio therapy dosed prediction.

The magnetic resonance only (MRO) planning is a technique used in radiation therapy for cancer treatment. MRO planning involves using magnetic resonance imaging (MRI) scans to create detailed images of the tumor and surrounding issues, and then using these images to plan the delivery of radiation therapy. In traditional radiation therapy planning, computed tomography (CT) scans are used to generate 3D images of the tumor and normal structures, which are then used to calculate the dose distribution delivered by the radiation beams. However, CT scans have limitation in terms of soft tissue contrast and resolution, making it difficult to accurately visualize of some types of tumors or distinguish them from surrounding tissues. MRO planning overcomes these limitations by using MRI scans instead of CT scans. MRI scans provide superior soft tissue contrast and resolution, allowing for more accurate delineation of the tumor and normal structures. This improved visualization can lead to more precise radiation therapy planning and delivery, potentially improving treatment outcomes and reducing side effects. MRO planning is particularly useful in treating tumors located in areas with complex anatomy, such as the brain or pelvis, where accurate targeting of the tumor is critical for minimizing damage to surrounding normal tissues.

Radiation therapy planning, also known as radio therapy treatment planning, is the process of designing a course of radiation therapy treatment for cancer patients. The goal of radiation therapy planning is to determine the optimal dose and configuration of radiation beams that will deliver the decided amount of radiation to the tumor while minimizing exposure to surrounding healthy tissues. The radiation therapy planning process typically involves the steps of imaging, target deviation, planning, quality assurance and treatment delivery. Radiation therapy planning is a complex process that requires careful consideration of many factors, including the size of the location of the tumor, the patients' anatomy and health status and the potential risks and benefits of the treatment. The goal of radiation therapy planning is to deliver the maximum possible dose to the tumor while minimizing exposure to surrounding healthy tissues, with the aim of improving treatment outcomes and reducing side effects.

Radio therapy dose prediction is the process of estimating the amount of radiation dose that will be delivered to a specific target volume or organ during radiation therapy treatment. This process involves using mathematical models, machine-learning algorithms or other computation methods to predict the dose distribution based on patient-specific data such as imaging scans, treatment plans, and clinical factors. Accurate dose prediction is important for example the treatment planning, the treatment verification also the patient monitoring. Over all, radiotherapy dose prediction is a complex process that requires careful consideration of many factors, including the accuracy and reliability of the prediction method, the quality and availability of patient-specific data, and the potential risks and benefits of treatment.

Therefore, the MR-only and RT planning system is facilitated by the artificial intelligence powered MR-based synthetic CT generation for convenient dosimetric planning. It is important to verify that the synthetic CT images generated by the artificial intelligence model are clinically viable for the RT planning. This is possible using voxel-wise uncertainty maps obtained using the methods described above. The proposed method further allows the computation of the uncertainty distribution of the complete training data set. The uncertainty map for a given test sample can be compared to the distribution using a standardized metric such as a z-score to highlight regions in the synthetic CT output with possible deviation from clinical viability.

AI powered radiation dose prediction for RT planning can be treated as a voxel-wise regression problem similar to the MR-only RT planning problems stated above. Therefore, the analyzation method based on standardized z-scores may also be applied here. Furthermore, scaling of the uncertainty maps proportional to the volume of the regions of interest (ROI) to improve the estimated bounds of the uncertainty and make the measure more interpretable is provided. The scaling factor is computed by aggregating the ratio of error in dose prediction to the raw uncertainty over voxels within the selected ROI, across all images in the validation data set and is sensitive to the composition and size of the validation data set. The proposed method allows the computation of such measures over the complete training data set, thereby better reflecting the population measure and mitigating the issues related to the composition of the validation data set.

In particular, the proposed method is a computer-implemented method. Therefore, one or more example embodiments relates to a computer program product comprising program code means for performing a method according to the proceeding aspect.

Furthermore, one or more example embodiments relates to a computer-readable storage medium comprising at least the computer program product according to the proceeding aspect.

One or more example embodiments relates to an electronic computing device for estimating a population uncertainty distribution of training data, wherein the electronic computing device is configured for performing a method according to the proceeding aspect. In particular, the method is performed by the electronic computing device.

Advantageous embodiments of the methods are to be regarded as advantageous embodiments of the computer program product, the computer-readable storage medium, as well as the electronic computing device. The electronic computing device therefore comprises means for performing the method.

A computing unit/electronic computing device may in particular be understood as a data processing device, which comprises processing circuitry. The computing unit can therefore in particular process data to perform computing operations. This may also include operations to perform indexed accesses to a data structure, for example a look-up table, LUT.

In particular, the computing unit may include one or more computers, one or more microcontrollers, and/or one or more integrated circuits, for example, one or more application-specific integrated circuits, ASIC, one or more field-programmable gate arrays, FPGA, and/or one or more systems on a chip, SoC. The computing unit may also include one or more processors, for example one or more microprocessors, one or more central processing units, CPU, one or more graphics processing units, GPU, and/or one or more signal processors, in particular one or more digital signal processors, DSP. The computing unit may also include a physical or a virtual cluster of computers or other of said units.

In various embodiments, the computing unit includes one or more hardware and/or software interfaces and/or one or more memory units.

A memory unit may be implemented as a volatile data memory, for example a dynamic random access memory, DRAM, or a static random access memory, SRAM, or as a non-volatile data memory, for example a read-only memory, ROM, a programmable read-only memory, PROM, an erasable programmable read-only memory, EPROM, an electrically erasable programmable read-only memory, EEPROM, a flash memory or flash EEPROM, a ferroelectric random access memory, FRAM, a magnetoresistive random access memory, MRAM, or a phase-change random access memory, PCRAM.

Independent of the grammatical term usage, individuals with male, female or other gender identities are included within the term.

In the figures the same elements are provided with the same reference signs.

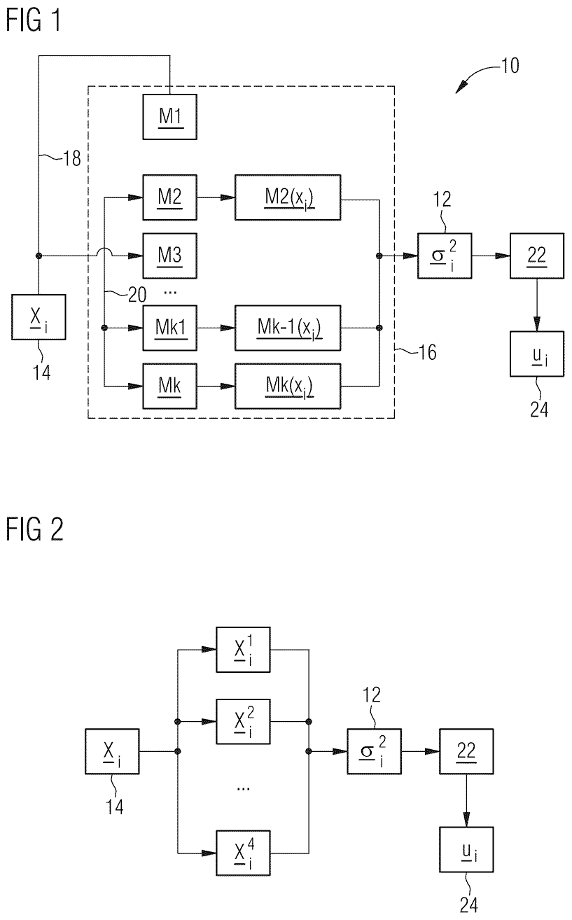

FIG. 1 shows a schematic block diagram according to an embodiment of an electronic computing device 10 for performing a method. In particular, the electronic computing device 10 is configured for estimating a population uncertainty distribution 12 of training data 14.

According to the embodiment, an artificial intelligence as an ensemble learner model 16 is provided, wherein the ensemble learner model 16 comprises at least two base learner M1-Mk. The training data 14 is provided for training the ensemble learner model 16. The training data 14 is separated into a first set 18 of training data 14 for training one of the at least two base learners M1-Mk and into a second set 20 of training data 14 for validating another one of the at least two base learners M1-Mk. The at least one base learner M1-Mk is trained with the first set of training data 18 and the population uncertainty distribution 12 is estimated by validating the other at least one base learner M1-Mk with the second set of training data 20 by the electronic computing device. As shown in FIG. 1 a first base learner M1 as well as a third base learner M3 is trained with the first set 18. A second base learner M2, a base learner Mk-1 as well as a base learner Mk is validated with the second set 20. Furthermore, a post-processing step 22 as well as an uncertainty score 24 is shown.

In particular, the training data 14 is separated by using a bootstrap aggregation algorithm. Furthermore, the training is performed for the half of the provided base learners M1-Mk. Furthermore, for validating the at least one base learner M1-Mk the training data 14 is perturbed in a pre-processing step, which is particularly shown in FIG. 2.

Depending on the estimated population uncertainty distribution 12, as already mentioned, an uncertainty score 24 for the training data 14 is determined. Furthermore, a plurality of training data 14 is provided and the artificial intelligence is trained and validated with a plurality of training data. Furthermore, an uncertainty score for the artificial intelligence is determined depending on an aggregation of the plurality of uncertainty scores 24 of each training data 14.

Furthermore, a Gaussian distribution is used for determining the uncertainty score for the artificial intelligence.

Model ensembles are generally created by varying the choice of training data for k base learners (Mᵢ, i∈[1, k]) within the ensemble. Bootstrap aggregation or bagging is an approach where the training dataset N is sampled with replacement k times to create subsets Nₖ to train base learners M1-Mk. One or more example embodiments proposes the use of residual bootstrapped subset (N-Nₖ) as the validation set for the kth base learner M1-Mk. Conversely, each training sample (xi) can be a part of the validation set for a maximum of (k−1) base learners M1-Mk and the corresponding uncertainty map

$$( {σ}_{i}^{2} )$$

can be computed. An example of this computation is shown in FIG. 1. A variation of bootstrapped aggregation may be used, where each training sample, which may be the training data 14, is only exposed to half the base learners M1-Mk during training, minimizing the overlap between subsets to increase diversity of the ensemble. The uncertainty map computation can be easily adapted to such a variation, where each training sample can be a part of the validation set for a maximum of (k/2) base learners M1-Mk.

Further, this computation lends itself equally to deterministic learning models trained using bootstrapped aggregation since it works directly with the network outputs and is applied post-training.

FIG. 2 shows another schematic block diagram according to one or more example embodiments. In the case of a single model (M) trained using a static training dataset, this computation can be applied via perturbation of training samples during evaluation. Each training sample (xi) can be perturbed k times to create unseen variants of the original training sample to constitute the corresponding validation subset. Such a validation subset can be evaluated using the trained model to obtain the uncertainty map

$$( {σ}_{i}^{2} )$$

as shown in FIG. 2. It is therefore possible to compute a conservative estimate of the underlying population (ID) uncertainty distribution 12 by iteratively computing the uncertainty map for every training sample.

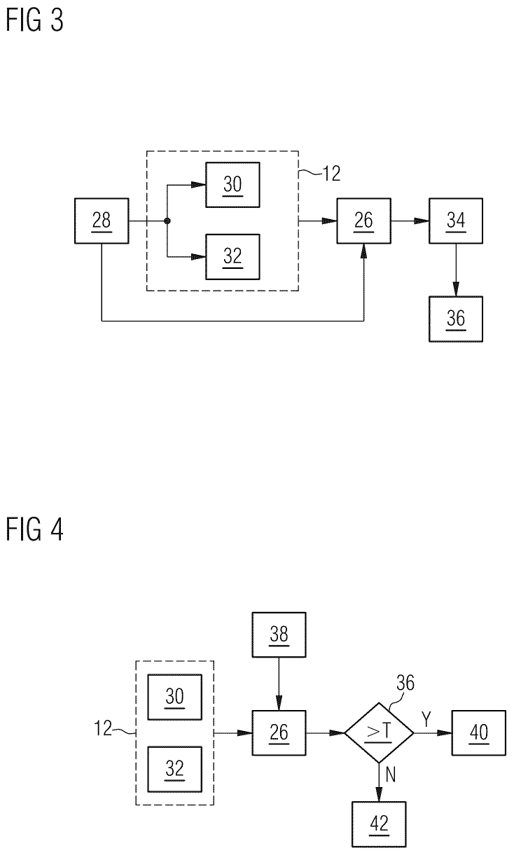

FIG. 3 shows another block diagram according to one or more example embodiments. In particular, FIG. 3 shows an example for statistical threshold selection based on the cumulative Mahalanobis distance 26. Therefore, FIG. 3 shows a so-called organ level uncertainty score for N which is shown with the reference sign 28. Furthermore, the uncertainty distribution 12 is shown. The uncertainty distribution 12 comprises for example class-wise means 30 as well as a shared covariance 32. Furthermore, the cumulative distribution 34 as well as a statistical threshold 36 is shown.

A voxel level uncertainty map

$$( {σ}_{i}^{2} )$$

can post-processed to obtain an uncertainty score 24 uᵢ, as shown in FIGS. 1 and 2. Note that the uncertainty score 24 can be aggregated at the organ level with dimensionality M in the case of multi-organ segmentation with M distinct organs.

One or more example embodiments proposes to approximate the uncertainty score distribution for the ID population by estimating M class-conditional Gaussian distributions [symbol] (μₘ, Σ), m∈[1, M] over uncertainty scores uᵢ computed for every training sample as explained above. Here,

$${μ}_{m} = \frac{1}{{N}_{m}} {\sum }_{i} {u}_{i , m}$$

represents the class-wise means, and

$$\sum = \frac{1}{N} {\sum }_{m = 1}^{M} {\sum }_{i} ( {u}_{i , m} - {μ}_{m} ) {( {u}_{i , m} - {μ}_{m} )}^{T}$$

is the covariance matrix, capturing shared uncertainties across classes.

For each input sample with a class-wise uncertainty score vector zᵢ the Mahalanobis distance to the above distribution [symbol] (μₘ, Σ) is given as

$$𝒟ℳ ( {z}_{i} , 𝒩 ( {μ}_{m} , \sum ) ) = \sqrt{{\sum }_{m = 1}^{M} {( {z}_{i , m} - {μ}_{m} )}^{T} {\sum }^{- 1} ( {z}_{i , m} - {μ}_{m} )}$$

and can be used as a metric.

One of the following methods of threshold selection may be utilized, based on the specific use case: The Mahalanobis distance ( [symbol] ) follows a χ²-distribution with degrees of freedom equal to the number of features (M: number of foreground classes in this formulation), allowing for the computation of a critical value for OOD detection at an application-specific significance level without necessitating OOD or ID test samples. A Mahalanobis distance value covering a critical, application-specific percentage of the cumulative [symbol] curve can be used as a threshold to distinguish OOD test samples. This method is depicted in the flow chart in FIG. 3. An operating point may be selected using class-wise performance curves based on a trade-off between accuracy and uncertainty. The [symbol] corresponding to the selected uncertainty score can be used as a threshold.

Note that only the training set is required for the threshold estimation, no OOD or control samples are utilized. Also, performance-based analysis can be extended further for calibration of the network based on uncertainty.

FIG. 4 shows another schematic block diagram according to an embodiment of the invention. In particular, FIG. 4 shows a method and an example of the out of distribution detection using the Mahalanobis distance 26 from the population uncertainty distribution 12. Therefore, FIG. 4 further shows the origin level uncertainty score for the test sample which is shown with the reference sign 38. Furthermore, if the Mahalanobis distance 26 is higher than the threshold 36 the test sample may be out of distribution, which is shown with the reference sign 40. Otherwise, if the Mahalanobis distance 26 does not exceed the threshold 36 the test sample may be inside of the population distribution, which is shown with the reference sign 42.

The process of OOD detection in the test set is shown in FIG. 4. The Mahalanobis distance 26 ( [symbol] ) between the test sample and ID distribution is computed and compared to the application-specific threshold selected using one of the methods above. The test sample is detected as OOD if [symbol] >T. The method has the capability to discriminate between ID (control) and OOD (implant, brachy) examples for an experimental use case.

The method according to one or more example embodiments provides a novel way of using the complete training dataset to compute a conservative estimate of the population (ID) uncertainty distribution 12. This computation is based on predicted uncertainty of the training data (ID) only and does not require the explicit presence of OOD samples for threshold selection. The method for a direct estimation of similarity of a test sample to the training (ID) distribution in the uncertainty space, independent of the network architecture or feature dimensionality. It can therefore be easily integrated into existing pipelines and used with pre-trained models trained using the bootstrap aggregate ensemble strategy.

Contrary to previous approaches, one or more example embodiments applies the Mahalanobis distance 26 to uncertainty scores 24 derived from class-conditional distributions, offering a novel method that circumvents the need for architectural changes and reduces the risk of feature collapse.

The method can be extended for use in applications beyond OOD detection with a metric chosen to be appropriate for the task at hand. Some examples are listed below.

Along with uncertainty, accuracy can also be evaluated over the entire training dataset using the proposed method. Statistical curves such as the Receiver operating characteristic (ROC), precision-recall (PR), or accuracy-vs-uncertainty (AvU) curves can then be used to select an operating point or threshold to characterize the performance on the test samples. The proposed method offers the advantage that the performance curves approximate population performance better, as compared to a smaller, separate validation set that is typically used.

Magnetic resonance (MR)-only radiation therapy (RT) planning: An MR-only RT planning system is facilitated by AI powered MR-based Synthetic CT (syn-CT) generation for convenient dosimetric planning. It is important to verify that the syn-CT images generated by the AI model are clinically viable for RT planning. This is possible using voxel-wise uncertainty maps obtained using the methods described in FIG. 1 or FIG. 2. The proposed method further allows the computation of the population uncertainty distribution 12 over the complete training dataset. The uncertainty map for a given test sample can be compared to this distribution using a standardized metric such as a z-score to highlight regions in the syn-CT output with possible deviation from clinical viability.

Radiotherapy dose prediction: AI powered radiation dose prediction for RT planning can be treated as a voxel-wise regression problem similar to the MR-only RT planning problem stated above. Therefore, the evaluation method based on standardized z-scores may also be applied here. Apart from this, scaling of the uncertainty maps proportional to the volume of individual regions of interest (ROI) to improve the estimated bounds of the uncertainty and make the measure more interpretable may be provided. The scaling factor is computed by aggregating the ratio of error in dose prediction to the raw uncertainty over voxels within the selected ROI, across all images in the validation dataset and is sensitive to the composition and size of the validation dataset. The proposed method allows the computation of such measures over the complete training dataset, thereby better reflecting the population measure and mitigating the issues related to the composition of the validation dataset.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAN), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

1. A method for estimating a population uncertainty distribution of training data by an electronic computing device, the method comprising:
providing an artificial intelligence as an ensemble learner model comprising at least two base learners by the electronic computing device;
providing the training data for training the ensemble learner model by the electronic computing device;
separating the training data into a first set of training data for training one of the at least two base learners and into a second set of training data for validating another one of the at least two base learners by the electronic computing device;
training the one of the at least one base learner with the first set of training data by the electronic computing device; and
estimating the population uncertainty distribution by validating the another at least one base learner with the second set of training data by the electronic computing device.

2. The method of claim 1, wherein the training data is separated using a bootstrap aggregation algorithm.

3. The method of claim 1, wherein the training is performed for half of the provided base learners.

4. The method of claim 1, wherein for validating the at least one base learner the training data is perturbed in a preprocessing step.

5. The method of claim 1, further comprising:
determining an uncertainty score for the training data based on the estimated population uncertainty distribution.

6. The method of claim 1, wherein the providing the training data provides a plurality of training data and the training trains the artificial intelligence and validates with the plurality of training data.

7. The method of claim 5, further comprising:
determining an uncertainty score for the artificial intelligence based on an aggregation of a plurality of uncertainty scores of each training data.

8. The method of claim 7, wherein the determining the uncertainty score uses a Gaussian distribution.

9. The method of claim 1, further comprising:
providing test data for the trained artificial intelligence; and
determining an affiliation of the test data to the distribution of the training data based on a difference threshold between the test data and the training data.

10. The method of claim 9, wherein a Mahalanobis distance is used for determining the difference between the test data and the training data.

11. The method of claim 9, wherein if the difference exceeds the threshold a warning message is generated.

12. The method of claim 1, wherein the artificial intelligence is used for at least one of a magnetic resonance only planning, a radiation therapy planning, or a radiotherapy dose prediction.

13. A non-transitory computer program product comprising program code, when executed by an electronic computing device, cause the electronic computing device to perform the method of claim 1.

14. A non-transitory computer-readable storage medium comprising program code, when executed by an electronic computing device, cause the electronic computing device to perform the method of claim 1.

15. An electronic computing device configured to perform the method of claim 1.

16. The method of claim 2, wherein the training is performed for half of the provided base learners.

17. The method of claim 16, wherein for validating the at least one base learner the training data is perturbed in a preprocessing step.

18. The method of claim 17, further comprising:
determining an uncertainty score for the training data based on the estimated population uncertainty distribution.

19. The method of claim 18, wherein the providing the training data provides a plurality of training data and the training trains the artificial intelligence and validates with the plurality of training data.

20. The method of claim 8, further comprising:
providing test data for the trained artificial intelligence; and
determining an affiliation of the test data to the distribution of the training data based on a difference threshold between the test data and the training data.
